(19) United States
(12) Patent Application Publication
(10) Pub. No.: US 2009/0167104 A1
(43) Pub. Date: Jul. 2, 2009

(54) Stackable brushless DC motor

(76) Inventors: Randy B. Dunn, City Of Industry, CA (US); James Banwell, City Of Industry, CA (US); Walter Holland, City Of Industry, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/318,626

(22) Filed: Jan. 2, 2009

Related U.S. Application Data
(60) Provisional application No. 61/018,520, filed on Jan. 2, 2008.

(51) Int. Cl. H02K 21/16; H02K 9/02; H02P 6/00

(52) U.S. Cl. 310/198; 310/60 A; 318/400.41

(57) ABSTRACT

The stackable brushless DC motor comprises one or more stackable motor sections disposed within a housing for use in cars or other vehicles. Each stackable motor section comprises a permanent magnetic rotor and electromagnetic stator. The permanent magnetic rotor comprises a plurality of permanent magnets. The electromagnetic stator comprises a plurality of conductive windings. The one or more stackable motor sections are characterized by a significantly thin and flat geometry. The housing comprises mounting flanges that support mounting in a car or other vehicle. The flat sides of the one or more stackable motor sections have no protuberances or features that would preclude adjacent stacking of said motors. The one or more stackable motor sections include openings through which a common shaft is disposed.

### CROSS-REFERENCE TO RELATED APPLICATION

This application claims the benefit of U.S. Provisional Patent Application Ser. No. 61/018,520, filed Jan. 2, 2008.

### BACKGROUND OF THE INVENTION

1. Field of the Invention

The present invention relates generally to electric motors, and, more particularly to “inrunner” brushless DC electric motors.

2. Description of the Related Art

Brushless DC electric motors have become the preferred motor type for many electrically powered systems. Brushless DC electric motors offer the advantage of accurate, variable speed control over a range of load conditions. Brushless DC electric motors can also produce full or nearly full rated torque over a range of load conditions. Brushless DC electric motors exhibit a high level of energy efficiency, often exceeding 90%, have high power-to-mass and power-to-volume ratios, and are very durable and reliable. These features make them ideally suited for use in electric vehicle applications.

The brushless DC electric motor is a synchronous electric motor comprising a moving rotor, stationary stator, and a housing. The stator includes coil wound electromagnets, and the rotor includes permanent magnets. The stator remains stationary while the rotor rotates during operation. Since the rotor operates by use of permanent magnets, there is no need for electrical contact with the rotor during operation.

This gets around the problem of how to transfer current to a moving armature, a significant benefit of the brushless DC electric motor. There are two common types of brushless DC electric motor configuration in use. In the outrunner configuration, the permanent magnet containing rotor spins around a coil-wound electromagnet stator. In the inrunner configuration, the coil wound electromagnet stator spins around a permanent magnet containing rotor. Due to mechanical and electromagnetic complexity, brushless DC electric motors can be very costly to design and manufacture for vehicle application.

The brushless DC electric motor employs an electronically controlled commutation system, instead of a mechanically controlled commutation system, such as is found in brush-type DC electric motors. Commutation is accomplished by the application of electrical energy to the electromagnets of the stator in order to motivate the rotor. This operation is done using a device known as an inverter. The inverter is an electric circuit comprising high speed switching devices, typically solid-state transistors, and a controller that interprets commands from the vehicle operator and stimulates the brushless DC electric motor through a multi-phase series of pulses in order to obtain the desired speed and torque for operation. Due to the complex nature of brushless DC electric motor operation, there is a need for intricate feedback loops involving a number of characteristic parameters unique to each design. Inverters are designed and configured specifically for the motor they are intended to control in order to obtain optimum performance. This is especially true for vehicle applications in which the motor does not run at a relatively fixed speed or performance level. Vehicles place significant demands on the motor and inverter during acceleration, ascent, decent, towing, and the like. As a result, inverter design, configuration and integration costs for the brushless DC electric motor for vehicle application are significant.

Brushless DC electric motors are sized according to the particular application. In vehicle application, this size can vary widely. For example, a motor bike or small commuter car may only require a 10 kW motor. This is sufficient to power such a vehicle under anticipated operating conditions. Larger luxury sedans may require 200 kW due to their substantially higher mass in order to achieve a satisfactory level of performance. Still higher performance luxury sedans, sports cars, as well as trucks, may need as much as 300 kW. Large work trucks, tow trucks, high end luxury cars and super cars may require 400 kW or more in order to realize their design goals.

Typically, a brushless DC electric motor in the vehicle is selected according the specific needs of the application. A manufacturer that makes a full product line of vehicles is required to utilize a number of different motor and inverter sizes and configurations in order to suit the various vehicles in the line. This is problematic in that it increases cost due to the fact that a number of different motors and inverters must be developed, deployed, and maintained. This is a result of the aforementioned significant development costs associated with brushless DC electric motors and inverters for vehicles.

Furthermore, development of a number of different motor sizes reduces the ability for the manufacturer to leverage economies of scale in production, since each size is amortized across a smaller number of vehicles. There remains the option to utilize a single large common motor and inverter configuration that suits all applications, but this is very inefficient as it adds unnecessary weight and cost to smaller vehicles that do not require such a configuration. Certain components, such as rare earth magnets used in the brushless DC electric motor are relatively expensive. Thus it is preferable to only use as little as is necessary in a particular target vehicle. Historically the individual brushless DC electric motors could not themselves be efficiently scaled according to each application.

One solution to the aforementioned problems is the installation of multiple motors onto a single axle or onto a common drive shaft. In this circumstance a single motor design can be applied to a wide range of vehicle needs. However, motors heretofore have not had the proper geometry or configuration required to fit tightly next to each other in a space efficient manner. The motors are relatively long with respect to their diameter and as such consume much of the linear space along a drive shaft or axle. Cooling ports, electrical connection points, housings, and other physical features are problematic when trying to fit a number of motors in a restricted volume of space. Space restrictions in most vehicles significantly limit the number of motors that can be placed efficiently. Regardless of the vehicle size, whether commuter car or larger truck, the space along the axles is relatively consistent, and the space adjacent to the drive shaft does not vary significantly. Limited available space makes installing multiple conventional motors problematic, especially when the number of co-located motors exceeds two or three motors. Placement of multiple motors along more than one axle increases the space available for the motors, but requires that the manufacturer accommodate a multi-axle drive situation. This adds to the vehicle cost in that the segregated motors must operate in concert, and wiring and cooling is complicated by having to support motors in multiple locations within the vehicle. Maintenance and assembly are also complicated since multiple motor locations must be dealt with.

It is desirable to have a single brushless DC electric motor design that can be easily scaled to suit a wide range of electric vehicle applications, takes advantage of production economies of scale, and significantly reduces redesign effort and associated cost. It is further desirable that when the brushless DC electric motor is significantly scaled that the geometry is conducive to installation, is space-efficient, and modular in order to reduce recurring costs of installation and maintenance. Further, it is desirable to have an inverter that supports such a brushless DC electric motor that scales with the brushless DC electric motor.

Thus, a stackable brushless DC motor solving the aforementioned problems is desired.

### SUMMARY OF THE INVENTION

The stackable brushless DC motor in a first embodiment includes a brushless DC electric motor having one or more stackable motor sections disposed within a housing. Each stackable motor section comprises a permanent magnet rotor comprising a plurality of magnets surrounded by an electromagnetic stator comprising a plurality of salient pole windings. The permanent magnet rotor and electromagnetic stator are disposed within each stackable motor section. The stackable motor sections have significantly flat geometry so that two or more brushless DC electric motor sections can be compactly stacked side by side directly adjacent to one another. The stackable motor sections are free from protuberances or other features that may preclude the ability to stack one next to another so that they are near to one another or even in direct contact with one another. One or more of the stackable motor sections can be disposed within a housing for use in cars or other vehicles. The housing has mounting flanges that support mounting in a vehicle. A hub is disposed within the center of each permanent magnet rotor and a common shaft is mechanically coupled to the stackable motor sections. The brushless DC electric motor comprises an external electrical interface for motor control. Optional liquid cooling conduit may be routed through the brushless DC electric motor and terminate at external liquid inlet and external liquid outlet connectors.

A second embodiment of the present invention includes a brushless DC electric motor for vehicle application of the first embodiment including an optional integrated inverter for each stackable motor section. The inverter is disposed within the housing and is electrically connected to the electromagnetic stator of the stackable motor section. The brushless DC electric motor comprises an external electrical interface for each stackable motor section for power and control operations.

These and other features of the present invention will become readily apparent upon further review of the following specification and drawings.

### BRIEF DESCRIPTION OF THE DRAWINGS

FIG. 1 is a diagrammatic end view of a stackable brushless DC electric motor comprising three stackable motor sections according to the present invention.

FIG. 2 is a diagrammatic view of a stackable brushless DC electric motor according to the present invention, shown through the axial center of the motor.

Similar reference characters denote corresponding features consistently throughout the attached drawings.

### DETAILED DESCRIPTION OF THE PREFERRED EMBODIMENTS

The first embodiment of the stackable brushless DC electric motor has one or more stackable motor sections disposed within a housing. Each stackable motor section comprises a permanent magnet rotor having a plurality of magnets surrounded by an electromagnetic stator having a plurality of salient pole windings. The permanent magnet rotor and electromagnetic stator are disposed within each stackable motor section. The stackable motor sections have significantly flat geometry so that two or more brushless DC electric motor sections can be compactly stacked side by side directly adjacent to one another. The stackable motor sections are free from protuberances or other features that may preclude the ability to stack one next to another such that they are near to one another or even in direct contact with one another. A hub is disposed within the center of each permanent magnet rotor and a common shaft is mechanically coupled to the stackable motor sections. The brushless DC electric motor comprises an external electrical interface for motor control. Optional liquid cooling conduit may be routed through the brushless DC electric motor and terminate at external liquid inlet and external liquid outlet connectors.

A second embodiment of the stackable brushless DC electric motor includes a brushless DC electric motor for vehicle application of the first embodiment described above, including an optional integrated inverter for each stackable motor section. The inverter is disposed within the housing and is electrically connected to the electromagnetic stator of the stackable motor section. The brushless DC electric motor comprises an external electrical interface for each stackable motor section for power and control operations.

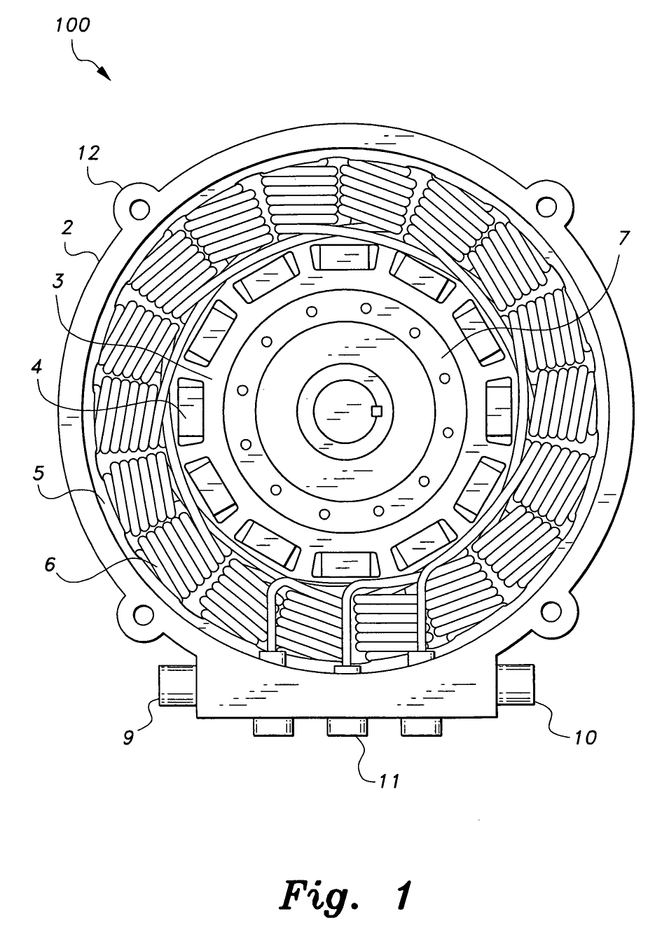

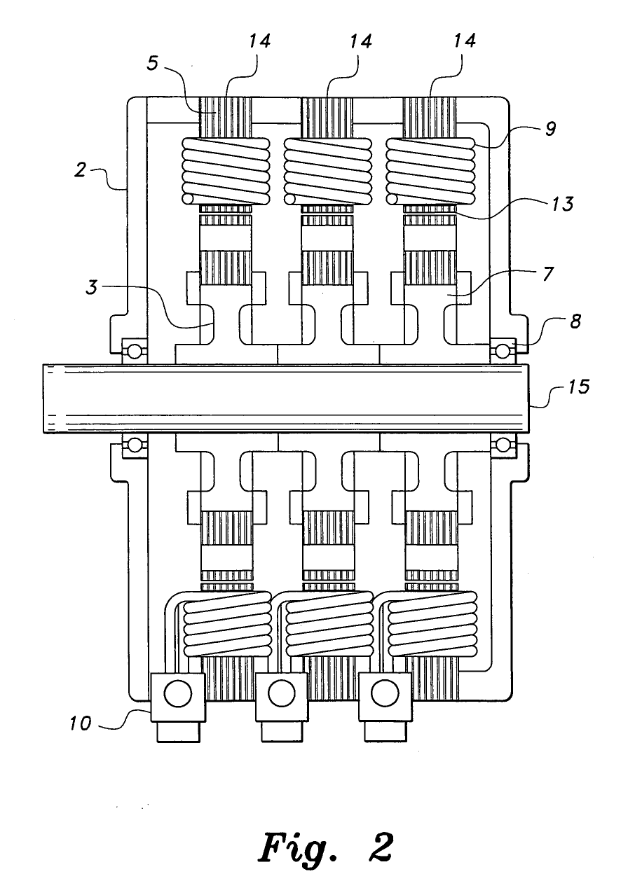

As shown in FIGS. 1 and 2, the stackable brushless DC electric motor 100 is an inrunner type and includes a housing 2 and three stackable motor sections 14. The stackable motor sections 14 are identical, each comprising a permanent magnet rotor 3 that includes a plurality of magnets 4 surrounded by an electromagnetic stator 5, the stator 5 having a plurality of salient pole windings 6. The stackable motor sections 14 are disposed within the housing 2. The permanent magnet rotor 3 of each stackable motor section 14 is characterized by a ring shape and includes a hub 7 at the center. The hub 7 of each stackable motor section 14 is mated to a splined shaft 15 that connects to the housing 2 through two or more bearings 8. Optional liquid cooling conduit may be routed through the brushless DC electric motor 100 and terminate at external liquid inlet 9 and external liquid outlet 10. An external electrical connector 11 provides electrical access to the salient pole windings 6 of the electromagnetic stator 5 of each stackable motor section 14. There is at least one external electrical connector 11 for each stackable motor section 14. The housing 2 includes a plurality of motor mount flanges 12, structural elements that allow the brushless DC electric motor 100 to be mechanically mounted to the vehicle.

It should be noted that FIGS. 1 and 2 merely depict one possible configuration that utilizes three stackable motor sections 14, and that fewer or more stackable motor sections 14 may be used without deviating from the spirit of the invention. By varying the number of stackable motor sections 14 disposed within the housing 2 of brushless DC electric motor 100, it becomes evident to one skilled in the art that a wide range of motor configurations are possible without necessitating significant redesign. In fact, only the housing 2 and splined shaft 15 need to be modified. It is further evident that the only significant change to housing 2 and splined shaft 15 is to vary them linearly to accommodate a different number of stackable motor sections 14. By permitting the reuse of a single design for stackable motor section 14, and reuse of the significant portions of a design for housing 2 and splined shaft 15, the motor 100 significantly reduces design, manufacturing, deployment, and maintenance costs. The ability to vary the number of stackable motor sections 14 in order to achieve different brushless DC electric motor 100 performance levels, defined herein as levels of power, torque, capacity, speed, duty cycle or durability, may be constructed from a single design such that high levels of economies of scale in manufacturing may be achieved.

The stackable motor section 14 has a thickness range of 0.5 to four inches, with a preferred thickness of one to three inches and a more preferred thickness of 1.5 to 2.5 inches. The stackable motor section 14 has a diameter ranging from 8″ to 18″, with a preferred diameter of 10″ to 16″ and a more preferred diameter of 12″ to 14″. The preferred ratio of diameter to thickness is 4:1 to 8:1, with a preferred ratio of 5.5:1 to 6.5:1. For example, a possible stackable motor section 14 of the present invention with a diameter of twelve inches would have a preferred thickness of two inches, and a resulting ratio of diameter to thickness of 6:1.

A preferred material for housing 2 is aluminum, but steel or other material suitable for an electric motor in the vehicle environment may be employed. The housing 2 may have liquid cooling conduit routed through it to support cooling operations by way of an external radiator and pump or similar means. The cooling feature may be applied external to the housing 2 in the form of cooling fins, a thermally conductive cold plate or similar means, with cooling performed through convention or conduction. Another approach disclosed in concurrently filed co-pending U.S. provisional patent application Ser. No. 61/013,328, entitled Brushless DC motor Including Tubular Conductive Coil Windings, the disclosure of which is incorporated herein by reference, is to use conductive tubular windings to conduct electrical current as well as carry a non-conductive liquid coolant, serving simultaneously as wires to induce magnetic flux and as a method of cooling the brushless DC electric motor 100. In this way, the cooling function is integrated into the stackable motor sections 14 directly, eliminating the need to integrate such cooling function into the housing 2. The benefits are evident in that a change to the size of the brushless DC electric motor 100 by changing the number of stackable motor sections 14 concurrently changes the cooling capacity of said motor. This simplifies the design of the motor housing, further reducing the costs associated with the housing 2 redesign for size variance accommodation. Regardless of architecture, the cooling function serves to remove heat from the brushless DC electric motor 100.

The electromagnetic stator 5 of each stackable motor section 14 is preferably made from laminated steel sheets. Such laminated sheets are well known to one skilled in the art to minimize the affects of eddy currents. Materials suitable for making the laminated steel sheets of electromagnetic stator 5 are low-carbon silicon-iron alloy, flat-rolled, grain oriented steels. One example is ASTM A876 available from ThyssenKrupp Electrical Steel of Gelsenkirchen, Germany. The number of salient pole windings 6 depends on the particular application, but is always a multiple of three. The salient pole windings 6 are comprised of electrical conductors 9 that are routed to an external electrical connector 11. These electrical conductors 9 are connected to a polyphase inverter and used to power, control, and drive the brushless DC electric motor 100 in a manner that would be well understood by one skilled in the art. Motor position can be determined by back electromotive force (EMF) interpreted from signals on the electrical conductors 9, or from an optional position encoder that can be attached to the permanent magnet rotor 3, splined shaft 15, vehicle drive shaft, or similar location. An insulating varnish is applied to the electromagnetic stator 5. Such varnish may include polyester varnish, epoxy varnish, epoxy polyester blend varnish, or similar material suitable for electric motor insulation. The varnish is applied as a thin layer and covers the outer surface of the electromagnetic stator 5, impregnating and filling the spaces between the individual coils of the salient pole windings 6.

The permanent magnet rotor 3 of each stackable motor section 14 is of similar construction to the electromagnetic stator 5 in that it is preferably made from laminated steel sheets. Materials suitable for making the laminated steel sheets of permanent magnet rotor 3 are low-carbon steels. One example is AISI1018 alloy, available from Olympic Steel of Bedford Heights, Ohio. As shown in FIG. 2, a plurality of magnets 4 are embedded into the permanent magnet rotor 3 in a conventional manner, such as by application of a silicon resin based adhesive, as is well known in the art. The magnets 4 are permanent types primarily made from rare earth materials, such as neodymium, samarium cobalt or similar material. The number of magnets 4 varies with a particular application, but is always a multiple of two. The magnets 4 are inserted into the permanent magnet rotor 3 with alternating pole orientation, north, south, north, south; and so on. The permanent magnet rotor 3 rotates in close proximity to electromagnetic stator 5, separated by a continuous separating air gap 13 that permits the permanent magnet rotor 3 to rotate freely in close proximity to electromagnetic stator 5 without contact.

At the center of the permanent magnet rotor 3 of each stackable motor section 14 is a hub 7 with an opening in the center that allows passage of, and coupling to, a splined shaft 15. The splined shaft 15 is common to all stackable motor sections 14 of brushless DC electric motor 100. The splined shaft 15 has a locking mechanism that may incorporate, for example, a keyed, splined, or similar form. For example a keyway may be cut into the shaft with hub 7 containing a key. Hub 7 locks into the keyway to achieve a reliable mechanical engagement when the brushless DC electric motor 100 drives the shaft. The splined shaft 15 passes through the length of the brushless DC electric motor 100 and is secured to two end plates of the housing 2. Each end plate contains a bearing 8 that allow the splined shaft 15 to spin freely within the housing 2. The bearings 8 are precision ball or roller bearing types. Additional center bearings may be required for brushless DC electric motors 1 for load distribution and stability improvement under certain circumstances including, for example, a large number of stackable motor sections 14, a heavy load application, or for increased reliability. The splined shaft 15 and hub are made from suitable materials such as steel or aluminum. The splined shaft 15 includes fan appropriate coupler mechanism that allows it to mechanically attach the drive shaft, axle, or other interface to drive the vehicle. Such couplers are well known in the automotive industry.

The housing 2 may incorporate an inverter to control each stackable motor section 14. The inverter comprises a set of solid-state switching elements and a controller module. Solid-state switching elements may take the form of power metal oxide semiconductor field-effect transistors (MOSFETs), insulated gate bipolar transistors (IGBTs) or similar high speed and high power switching devices. The switching elements are wired directly to salient pole windings 6 of electromagnetic stator 5. The brushless DC electric motor 100 is driven by the switching elements through voltage patterns coupled with the given rotor position. The generated electromagnetic stator 5 flux interacts with the permanent magnet rotor 3 flux, which is generated by a magnet 4, to define the torque and speed of the brushless DC electric motor 100. The voltage patterns are applied in accordance with formula and processes understood by one skilled in the art. Execution of these time critical control algorithms requires a control module. The control module is a microprocessor, microcontroller, application specific integrated circuit (ASIC), field programmable gate array (FPGA), or similar programmable device capable of executing the real-time algorithmic processing necessary to control the brushless DC electric motor 100.

It is to be understood that the present invention is not limited to the embodiments described above, but encompasses any and all embodiments within the scope of the following claims.

We claim:

1. A stackable brushless DC motor, comprising:
a plurality of stackable motor sections, each of the sections including a stationary electromagnetic stator having a plurality of salient pole windings and an annular rotor having a plurality of permanent magnets mounted thereon, the rotor being rotatable within the stator;
a common shaft;
a plurality of central hubs, each of the rotors having a corresponding one of the central hubs;
means for selectively mounting at least one and up to all of the stackable motor sections on the common shaft and locking the rotors thereof to the shaft so that the shaft rotates with the rotors; and
a housing, the common shaft being rotatably mounted in the housing, the housing being dimensioned and configured for enclosing all of the stackable motor sections therein when all of the stackable motor sections are mounted on the common shaft.

2. The stackable brushless DC motor according to claim 1, further comprising an external electrical connector electrically connected to the plurality of salient pole windings of each said stackable motor section.

3. The stackable brushless DC motor according to claim 1, wherein each said stackable motor section has a corresponding said electrical connector electrically connected thereto.

4. The stackable brushless DC motor according to claim 1, wherein said means for selectively mounting and locking comprises a plurality of splines disposed on said shaft, each said central hub having mating splines.

5. The stackable brushless DC motor according to claim 1, wherein said means for selectively mounting and locking comprises a key projecting from said shaft, each said central hub having a mating keyway defined therein.

6. The stackable brushless DC motor according to claim 1, wherein said means for selectively mounting and locking comprises a keyway defined in said shaft, each said central hub having a mating key projecting therefrom.

7. The stackable brushless DC motor according to claim 1, wherein at least one of the motor sections has a thickness between approximately 0.5 and 4 inches and a diameter between about 8 inches to 18 inches.

8. The stackable brushless DC motor according to claim 7, wherein the ratio of the diameter to the thickness is between about 4:1 to 8:1.

9. The stackable brushless DC motor according to claim 1, a conduit extending through the housing adapted for circulating coolant in order to cool the motor.

10. The stackable brushless DC motor according to claim 1, further comprising heat dissipation fins disposed on said housing for cooling the motor.

11. The stackable brushless DC motor according to claim 1, wherein the housing includes at least one heat conducting plate for cooling the motor.

12. The stackable brushless DC motor according to claim 1, wherein the salient pole windings comprise tubular electrically conducting members containing a non-conductive liquid coolant.

13. The stackable brushless DC motor according to claim 1, wherein the number of salient pole windings in each said stator is a multiple of three windings.

14. The stackable brushless DC motor according to claim 1, wherein the number of permanent magnets is a multiple of two in an alternating north-south orientation.

15. The stackable brushless DC motor according to claim 1, further comprising a position encoder in operable communication with the rotors.

16. The stackable brushless DC motor according to claim 1, further comprising an integrated inverter module in operable communication with said stators.
